(19) United States
(12) Patent Application Publication
(10) Pub. No.: US 2019/0158953 A1
(43) Pub. Date: May 23, 2019

(54) LOUDSPEAKER MODULE

(71) Applicant: Goertek Inc., Shandong (CN)

(72) Inventors: Yue Shang, Shandong (CN); Shuzhi Zhou, Shandong (CN)

(21) Appl. No.: 15/759,542

(22) PCT Filed: Nov. 16, 2015
(86) PCT No.: PCT/CN2015/094686

§ 371 Date: Mar. 13, 2018

(30) Foreign Application Priority Data
Sep. 15, 2015 (CN) 201520713869.0

(51) Int. Cl. H04R 1/28; H04R 1/02

(52) U.S. Cl. CPC H04R 1/2857; H04R 2499/11; H04R 1/025

(57) ABSTRACT

A loudspeaker module comprising a peripheral housing and a loudspeaker unit accommodated inside the peripheral housing, wherein the loudspeaker unit comprises a diaphragm sheet, a side wall of the peripheral housing is provided with a side sound hole of the loudspeaker module, a space formed by the diaphragm sheet, the peripheral housing and the side sound hole is a sound channel of a front acoustic cavity, the sound channel comprises a root portion close to the diaphragm sheet, an opening portion close to the side sound hole and side walls connecting the root portion and the opening portion and arranged oppositely, the side walls comprise a straight side wall and a bent side wall, and the width of the root portion of the sound channel is greater than the width of the opening portion. By means of the loudspeaker module in the present invention, sound waves may be transmitted more smoothly in the sound channel, and reflection and interference of the sound waves caused by the side walls of the sound channel are reduced, so that minimization of high order harmonic distortion can be effectively achieved, and the product tone quality is effectively improved.

### CROSS-REFERENCE TO RELATED APPLICATIONS

This application is a National Stage of International Application No. PCT/CN2015/094686, filed on Nov. 16, 2015, which claims priority to Chinese Patent Application No. 201520713869.0, filed on Sep. 15, 2015, both of which are hereby incorporated by reference in their entireties.

### BACKGROUND

### Technical Field

The present invention relates to the field of electroacoustics, and in particular, to a loudspeaker module.

### Description of Related Art

As a device for converting electrical energy into sound energy, a loudspeaker is widely used in terminal electronic devices such as mobile phones, computers, MP3 and PAD. In the prior art, when the loudspeaker is assembled with a terminal device, it usually needs to place a loudspeaker unit into an outer housing which accommodates the single body, and then the loudspeaker is assembled into the terminal device, such as a mobile phone, in the form of a module.

With the rapid development of science and technology as well as electronic industry, people present higher demands on the performance of loudspeaker products. In the current market environment, it not only requires that the loudspeaker module makes loud sound and has better sound quality, but also requires that harmonic distortion thereof is reduced, which sets a stricter standard for a harmonic distortion test of the loudspeaker products and is a great challenge for listening and the test of the loudspeaker products under a high voltage. However, for an existing loudspeaker module structure, a sound channel thereof takes a wide variety of designs. The design of part of sound channels can realize that a high-order harmonic distortion test is qualified under a rated voltage, but hardly realize that related tests are qualified under a high voltage. Therefore, for this problem, there is still an urgent need of making further improvement and exploration on the design of the sound channel.

### BRIEF SUMMARY

The technical problem to be solved by the present invention is to provide a loudspeaker module. By designing a sound channel structure of the loudspeaker module, the high-order harmonic distortion of the loudspeaker module is reduced and thus the sound quality of loudspeaker module is improved.

In order to achieve the above purpose, the present invention adopts the following technical solution. A loudspeaker module comprises a housing and a loudspeaker unit accommodated in the housing, wherein the loudspeaker unit comprises a vibration diaphragm; a side sound hole of the loudspeaker module is arranged on a side wall of the housing; a space formed among the vibration diaphragm, the housing, and the side sound hole is a sound channel of a front acoustic cavity; the sound channel comprises a root part close to the vibration diaphragm, an opening part close to the side sound hole, and a side wall connected to the root part and the opening part; the side wall comprises a flat and straight side wall and a bent side wall, which are oppositely arranged; and the width of the root part of the sound channel is greater than the width of the opening part.

As an improvement, the housing comprises an upper housing and a lower housing cooperating with the upper housing; and the side sound hole is arranged on a side wall of the upper housing.

As an improvement, the side wall of the sound channel of the loudspeaker module is a side wall arranged on the upper housing.

As an improvement, the flat and straight side wall is perpendicular to the root part of the sound channel and extends towards a direction of the opening part flatly and straightly.

As an improvement, the bent side wall comprises a flat and straight part perpendicular to the root part, and a bent part; and the bent part extends towards the direction of the opening part and is smoothly coupled to the opening part.

As an improvement, the bent part gradually approximates the flat and straight side wall of the sound channel of the loudspeaker module; and a part, close to the opening part, of the sound channel contracts inwards.

As an improvement, the length of the flat and straight part is ½ of the length of the bent side wall in a direction perpendicular to the root part of the sound channel.

As an improvement, the side sound hole is arranged along a direction parallel to the vibration diaphragm.

As an improvement, the loudspeaker module is further provided with a PET sheet for sealing the front acoustic cavity and a rear acoustic cavity.

When the loudspeaker module of the present invention is compared with the prior art, the sound channel thereof comprises a root part close to the vibration diaphragm, an opening part close to the side sound hole, and a side wall connected to the root part and the opening part. The side wall comprises a flat and straight side wall and a bent side wall, which are oppositely arranged. Moreover, the width of the root part of the sound channel is greater than the width of the opening part. With such a structural design, sound waves can propagate more smoothly in the sound channel, and reflection of and interference to the sound waves caused by the side wall of the sound channel are reduced. Therefore, the high-order harmonic distortion is minimized effectively, and thus the sound quality of the loudspeaker can be effectively improved. Hence, the sound is more clear and pleasant, and brings more wonderful acoustic enjoyment to the audience. The current increasing demands on the performance of the loudspeaker products can also be met.

### BRIEF DESCRIPTION OF THE FIGURES

FIG. 1 is an exploded view of the loudspeaker module structure of the present invention; and

FIG. 2 is a sectional view of the loudspeaker module structure of the present invention.

The reference signs represent the following components: 1: upper housing; 2: lower housing; 3: loudspeaker unit; 4: sound channel; 41: root part; 42: opening part; 43: flat and straight side wall; 44: bent side wall; 440: flat and straight part; 441: bent part; and 5: PET sheet.

### BRIEF DESCRIPTION OF THE VARIOUS EMBODIMENTS

The present invention is described in detail below in conjunction with the accompanying drawings.

### Embodiment

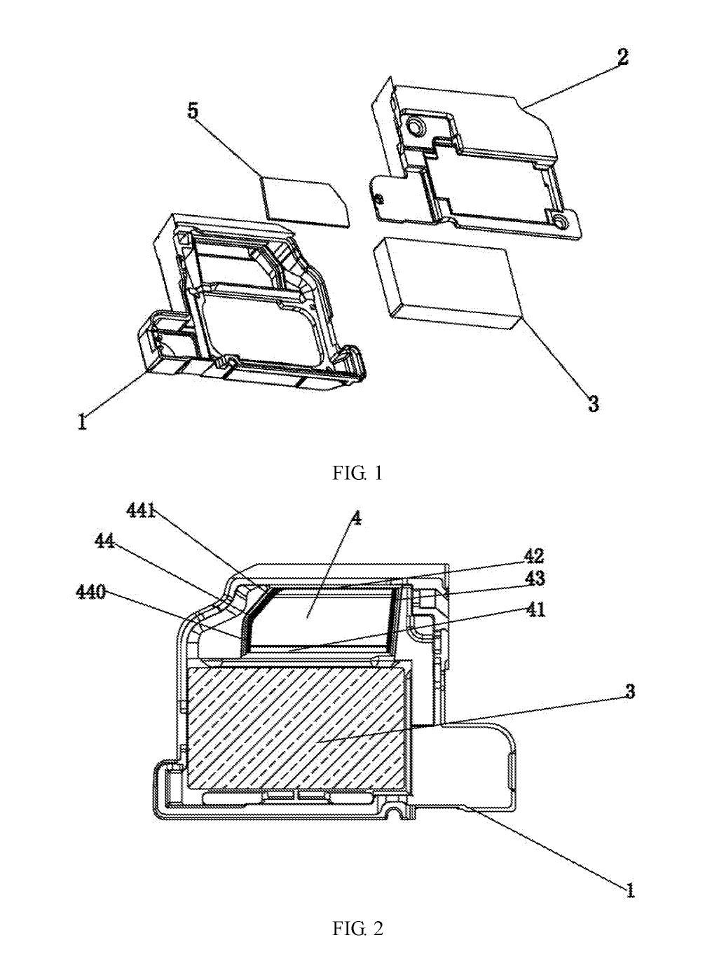

With reference to FIGS. 1 and 2, the loudspeaker module of the present invention comprises a housing and a loudspeaker unit accommodated in the housing. In a specific implementation mode, the housing comprises an upper housing 1 and a lower housing 2, which cooperate with each other to form a chamber. The loudspeaker unit 3 is accommodated in the chamber. As a basic sound production unit, the loudspeaker unit 3 specifically comprises a magnetic circuit system, a vibration system and an auxiliary system. The vibration system comprises a vibration diaphragm (not shown) which can produce sound under the driving of a voice coil. The vibration diaphragm is vibrated under the driving of the voice coil to generate sound waves. A sound channel (i.e., a channel, through which the sound waves radiate outwards) is cooperatively arranged in an inner chamber of the loudspeaker. An outlet (i.e., a sound hole) of the sound waves is arranged on an outer housing. The present implementation mode shows a loudspeaker module which makes sound from a side. A side sound hole is arranged on a side wall of a housing thereof, specifically on a side wall of the upper housing 1. A sound channel 4 of a front acoustic cavity is a channel from a position (the vibration diaphragm), where sound is produced, to the side sound hole, and is formed by the vibration diaphragm, the housing and the side sound hole cooperatively.

With reference to FIG. 2, the sound channel 4 comprises a root part 41 close to the vibration diaphragm, an opening part 42 close to the side sound hole, and a side wall (the side wall herein is actually a side wall arranged on the upper housing 1) connected to the root part 41 and the opening part 42. In the loudspeaker module of the present invention, the side wall of the sound channel 4 thereof comprises a flat and straight side wall 43 and a bent side wall 44, which are oppositely arranged. The flat and straight side wall 43 is perpendicular to the root part 41 of the sound channel and extends towards a direction of the opening part 42 flatly and straightly, while the bent side wall 44 is of a bent structure, and specifically comprises a flat and straight part 440 and a bent part 441. The flat and straight part 440 is also perpendicular to the root part 41 of the sound channel while the bent part 441 extends towards the direction of the opening part 42 and is smoothly coupled to the opening part 42. In addition, the bent part 441 of the bent side wall 44 gradually approximates the flat and straight side wall 43 in an extending process, that is, a part, close to the opening part 42, of the sound channel 4 contracts inwards. In other words, the width of the root part 41 of the sound channel is greater than the width of the opening part 42.

By means of the above technical solution, the side wall of the sound channel of the loudspeaker module which makes sound from a side is designed to be of a structure with one flat and straight side and one bent side, and it is guaranteed that the root part is wider than the opening part. Thus, sound waves can propagate more smoothly in the sound channel, and reflection of and interference to the sound waves caused by the side wall of the sound channel are reduced. Therefore, high-order harmonic distortion is minimized effectively, and thus the sound quality of the loudspeaker can be effectively improved.

Preferably, the length of the flat and straight part 440 is ½ of the length of the bent side wall 44 in a direction perpendicular to the root part 41 of the sound channel. During specific implementation, the effects of the present technical solution can be achieved, so long as the side wall of the sound channel is flat and straight on one side and is bent on the other side, and the width of the root part 41 is greater than the width of the opening part 42. The FIG. 1/2 illustrated herein is only an optimized design of the solution. That is, if it is assumed that the length of the bent side wall 44 in the direction perpendicular to the root part 41 of the sound channel is L, the effects are optimal when the length of the flat and straight part 440 is ½L.

Preferably, the side sound hole is arranged along a direction parallel to the vibration diaphragm. When the vibration diaphragm is vibrated under the driving of a voice coil, the sound waves can propagate to the side sound hole through the sound channel more smoothly.

Preferably, a polyethylene terephthalate (PET) sheet is further arranged in the chamber of the loudspeaker module for sealing the front acoustic cavity and a rear acoustic cavity of the module.

It should be noted that the present technical solution is mainly suitable for the loudspeaker module which produce sound from a side. In the module structure shown in the present implementation mode, an outer housing thereof comprises an upper housing and a lower housing. Actually, the present technical solution is not limited to the above module structure with a housing comprising two parts, and is also suitable for modules comprising three parts, namely, an upper housing, a middle module housing and a lower housing, without being affected thereby. Likewise, no matter in which part of the housing the side sound hole is arranged, the technical solution is not affected as soon as the design of the sound channel thereof meets the requirements of the present solution.

The above contents are merely implementation cases of the present invention and are not intended to limit the present invention. All the equivalent modifications or changes made by those of ordinary skill in the art according to the content of the present invention shall fall within the protection scope defined by the claims.

1-9. (canceled)

10. A loudspeaker module comprising:
a housing; and
a loudspeaker unit accommodated in the housing,
wherein the loudspeaker unit comprises a vibration diaphragm,
wherein a side sound hole of the loudspeaker module is arranged on a side wall of the housing,
wherein a space formed among the vibration diaphragm, the housing, and the side sound hole is a sound channel of a front acoustic cavity,
wherein the sound channel comprises a root part close to the vibration diaphragm, an opening part close to the side sound hole, and a side wall connected to the root part and the opening part, and
wherein the side wall comprises a flat and straight side wall and a bent side wall, which are oppositely arranged; and the width of the root part of the sound channel is greater than the width of the opening part.

11. The loudspeaker module of claim 10, wherein the housing comprises an upper housing and a lower housing cooperating with the upper housing; and the side sound hole is arranged on a side wall of the upper housing.

12. The loudspeaker module of claim 11, wherein the side wall of the sound channel of the loudspeaker module is a side wall arranged on the upper housing.

13. The loudspeaker module of claim 10, wherein the flat and straight side wall is perpendicular to the root part of the sound channel and extends towards a direction of the opening part flatly and straightly.

14. The loudspeaker module of claim 10, wherein the bent side wall comprises a flat and straight part perpendicular to the root part, and a bent part; and the bent part extends towards the direction of the opening part and is smoothly coupled to the opening part.

15. The loudspeaker module of claim 14, wherein the bent part gradually approximates the flat and straight side wall of the sound channel of the loudspeaker module; and a part, close to the opening part, of the sound channel contracts inwards.

16. The loudspeaker module of claim 5, wherein the length of the flat and straight part is ½ of the length of the bent side wall in a direction perpendicular to the root part of the sound channel.

17. The loudspeaker module of claim 10, wherein the side sound hole is arranged along a direction parallel to the vibration diaphragm.

18. The loudspeaker module of claim 10, wherein the loudspeaker module is further provided with a PET sheet for sealing the front acoustic cavity and a rear acoustic cavity.
